(19) United States
(12) Patent Application Publication
(10) Pub. No.: US 2008/0069934 A1
(43) Pub. Date: Mar. 20, 2008

(54) COHESIVE NON-FREE FLOWING SWEETENER COMPOSITIONS CONTAINING DISINTEGRANT

(76) Inventors: Renny Ison, Great Kingshill (GB); Melanie Loades, West Byfleet (GB); Gareth Williams, Reading (GB)

Correspondence Address: PHILIP S. JOHNSON;JOHNSON & JOHNSON, ONE JOHNSON & JOHNSON PLAZA, NEW BRUNSWICK, NJ, 08933-7003, US

(21) Appl. No.: 11/532,687

(22) Filed: Sep. 18, 2006

(51) Int. Cl. A23L 1/236

(52) U.S. Cl. 426/548

(57) ABSTRACT

Cohesive non-free flowing compositions for adding sweetness to liquid foodstuffs, for example, beverages, having a reduced caloric burden as compared to conventional sucrose cubes, are provided. More particularly, a low calorie Cohesive non-free flowing compositions containing a high intensity sweetener, a bulking agent, and a disintegrant, wherein a sweetener cube formed from the cohesive non-free flowing sweetener composition having about the same dimensions as a convention sucrose cube has a lower caloric burden and an equivalent sweetness is disclosed. Also provided are cohesive non-free flowing compositions containing sucralose, carboxymethyl cellulose, polydextrose, trehalose, and erythritol, wherein a sweetener cube formed from the cohesive non-free flowing composition having about the same dimension as a conventional sucrose cube has a lower caloric burden and a equivalent sweetness. Methods of making such sweetener cubes are also provided.

### FIELD OF THE INVENTION

The present invention relates to cohesive non-free flowing sweetener compositions with decreased caloric burden compared to conventional sucrose cubes of similar size for delivering sweetness to an aqueous foodstuff for example, a beverage. More particularly, the present invention relates to cohesive non-free flowing sweetener compositions containing a high intensity sweetener, a bulking agent, and a disintegrant, wherein the sweetener cube formed from a cohesive non-free flowing sweetener composition has a lower caloric burden and an equivalent sweetness compared to a sucrose cube of about the same dimensions. The present invention also relates to methods for making such s cohesive non-free flowing sweetener compositions.

### BACKGROUND OF THE INVENTION

People often add sweeteners to their foods and beverages. For example, sweeteners are added to beverages, such as, coffee and tea. Sweetening a food or beverage alters its flavor and usually increases its appeal. This behavior is found in all cultures, but is especially prevalent in western cultures.

Personal taste creates considerable variability in the amount of sweetness that one person prefers in a given food or beverage versus another person. For example, the amount of sweetness incorporated into a foodstuff during commercial production may not be adequate to satisfy some consumers while other consumers may find that the same amount of sweetness to be excessive. Moreover, consumers often desire to reduce their caloric intake for health or lifestyle reasons. Therefore, there exists a long-felt need for sweetener products that consumers may use to increase the sweetness of a product at the time of consumption that are consistent with their personal preferences and minimize additional caloric burden.

Methods for sweetening liquid foodstuffs are known. For example, adding sweetener to an unsweetened iced tea beverage will typically involve adding the sweetener to the unsweetened iced tea beverage followed by stirring to disperse the sweetener to create a sweetened iced tea beverage. Such a sweetener is typically in a cube, tablet, granular, powdered, or liquid form.

Sweetening individual servings of a beverage presents a challenge in many food service situations. Frequently, an individual packet of a sweetener is provided along with a serving of a beverage. The packet may contain sucrose, or alternatively may contain high intensity sweeteners such as sucralose, aspartame, or saccharin and a standard bulking agent such as sucrose, glucose or maltodextrin; all of which have a typical calorific value of 4 kilocalories per gram. The user must open the packet and empty the contents into the beverage, and then stir the beverage to obtain dissolution of the sweetener and its complete dispersion in the liquid. The residual packaging of the packet creates waste that may present disposal problems under many situations. Alternatively, sweetener may be provided in the form of a single serve cohesive non-free flowing sweetener composition, which contains approximately one (or more) sucrose equivalent teaspoon(s) of sweetness (one sucrose equivalent teaspoon being about 4 to about 5 grams per teaspoon of sucrose). Typically, such sweetener cubes do not require individual packaging, and therefore, reduce the steps involved in sweetening the beverage and the waste associated with the sweetener.

Sweetener cubes are cohesive non-free flowing compositions that include bulking agents. Bulking agents are typically crystalline carbohydrates, such as, sucrose, which are also available in combination with high intensity sweeteners. More recently a number of lower caloric burden bulking agents have entered the market. Some of these lower caloric burden bulking agents have physical and sensory characteristics similar to sucrose, and others have only a few physical or sensory characteristics similar to sucrose and/or some undesirable characteristics.

The availability of high intensity sweeteners provide the ability to lower the caloric burden involved with sweetening a liquid foodstuff, e.g., individual servings of beverages. For example, sucralose is about 500 to about 600 times as sweet as sucrose (a.k.a. table sugar and cane sugar). One teaspoon of sucrose, which is about 4 to about 5 grams of sucrose, may be replaced by about 6.7 to about 10 milligrams of sucralose. The minute quantities of high intensity sweeteners needed to achieve preferred sweetening of individual servings offer the opportunity to provide new technologies to deliver sweetness to foodstuffs, including individual servings.

In view of the foregoing, there is a need to provide cohesive, non-free flowing sweetener compositions having a lower caloric burden while having similar physical and sensory characteristics to those of a typical sucrose sweetener cube.

### SUMMARY OF THE INVENTION

One embodiment of the present invention is a cohesive non-free flowing sweetener composition comprising, consisting of, and/or consisting essentially of a sweetening amount of a intensity sweetener, an effective amount of a bulking agent, and a effective amount of a disintegrant, wherein a sweetener cube formed from the cohesive non-free flowing sweetener composition having about the same dimensions as a convention sucrose cube has a lower caloric burden and an equivalent sweetness and the bulking agent and disintegrant are different substances.

Another embodiment of the present invention is a cohesive non-free flowing sweetener composition comprising, consisting of, and/or consisting essentially of about 0.3% to about 0.6% sucralose, about 0.1% to about 5% carboxymethyl cellulose, about 5% to about 10% polydextrose, about 14% to about 15% trehalose, and about 60% erythritol by weight based on the total weight of the cohesive non-free flowing sweetener, wherein the cohesive non-free flowing sweetener composition has a lower caloric burden and a equivalent sweetness to a shaped sucrose composition of similar size.

A further embodiment of the present invention is a cohesive non-free flowing sweetener composition comprising, consisting of and/or consisting essentially of about 0.57% sucralose, about 5% carboxymethyl cellulose, about 5% polydextrose, about 14% trehalose, and about 60% erythritol by weight based on the total weight of the sweetener cube, wherein the cohesive non-free flowing sweetener composition has a lower caloric burden and a equivalent sweetness to a shaped sucrose composition of similar size.

An additional embodiment of the present invention is a method for making a low-calorie sweetener cohesive non-free flowing composition comprising, consisting of, and/or consisting essentially of the steps of combining a high intensity sweetener, bulking agent, and a disintegrant to form a blend, wherein the bulking agent and disintegrant are different substances, adding water to the blend, forming the blend into a shape, and drying the shape.

### BRIEF DESCRIPTION OF THE DRAWINGS

FIG. 1 shows the effect on the caloric burden of a sweetening cube by changing the proportion of various potential bulking agents compared to a sweetener cube made from a reference blend.

FIG. 2 shows the effect on friability over a range of relative humidities of changing the proportion of various potential bulking agents compared to a sweetener cube made from a reference blend.

FIG. 3 shows the disintegration times for various sweetener cube and a control cube with no disintegrant formulations (Example 3—Table 4) at ambient temperature and at 55° C.

### DETAILED DESCRIPTION OF THE INVENTION

To reduce the caloric burden of a sucrose cube, the amount of sucrose is decreased, which results a smaller cube size. Heretofore, the use of ingredients other than sucrose in a sweetener cube may be problematic with regard to sweetener cube production, storage, and consumer appeal and acceptance. The sweetness lost due to the decreased amount of sucrose in the cube the sucrose must be replaced partially or in whole by lower calorie sweetener ingredients. This can be achieved by incorporating high intensity sweeteners, such as, aspartame or acesulfame K into the cube formulation. While such a formulation does reduce the cube's caloric burden, this reduction is limited by the minimum size of the cube that can be manufactured and handled by the consumer. A review of products currently on the market revealed a minimum cube size of about 1.4 grams, which results in a sucrose-containing sweetener cube having about 5.6 kilocalories.

Moreover, to produce a low calorie sweetener cube that looks like a conventional sucrose cube, one or more bulking agents may be incorporated into the cube. The use of such bulking agents may produce a sweetener cube that is insufficiently robust (i.e., with a low friability) to withstand the stresses resulting from the normal production and packaging processes for conventional sucrose cubes, Such cubes do not retain their shape and lose a significant amount of the particles making up the cube. To overcome these deficiencies, such cubes would need to be individually wrapped thus increasing costs and waste.

As used herein, the term “conventional sucrose cube” means a rectangular prism of crystalline sucrose having a height, width, and depth from about 5 millimeters to about 20 millimeters. Typically, a conventional sucrose cube is about 15 millimeters on each side and has a caloric burden of about 25 kilocalories. As noted above, the smallest commercially available and consumer accepted high intensity sweetener/sucrose cubes are about 9 millimeters by 12 millimeters by 12 millimeters on each side and have a caloric burden of about 5.6 kilocalories and weight of about 1.4 grams.

As used herein, all numerical ranges provided are intended to expressly include at least all numbers that fall between the endpoints of recited ranges.

One embodiment of the present invention is a sweetener cube containing a high intensity sweetener, a bulking agent, and a disintegrant, wherein the sweetener cube has a lower caloric burden than that of a conventional sucrose cube of about the same dimensions and the sweetener cube has a sweetness equivalent to about one teaspoon of sucrose.

As used herein, the term “teaspoon” refers to a standard teaspoon, which has a volume of about 5 milliliters. Accordingly, a teaspoon of sucrose has a mass of about 4 to about 5 grams.

### High Intensity Sweetener

As used herein, the term “high intensity sweetener” means a substance that provides a high sweetness per unit mass as compared to sucrose and provides little or no nutritive value.

Many high intensity sweeteners are known to those skilled in the art and any can be used in the present invention. Examples of high intensity sweeteners for use in the present invention include aspartame, acesulfame, alitame, brazzein, cyclamic acid, dihydrochalcones, extract of Dioscorophyllum cumminsii, extract of the fruit of Pentadiplandra brazzeana, glycyrrhizin, hernandulcin, monellin, mogroside, neotame, neohesperidin, saccharin, sucralose, stevia, thaumatin, salts, derivatives, and combinations thereof. A preferred high intensity sweetener according to the present invention is sucralose.

Cohesive non-free flowing sweetener compositions of the present invention may contain from about 0.01% (wt) to about 3.5% (wt) of a high intensity sweetener. More preferably, the sweetener cubes of the present invention contain from about 0.05% (wt) to about 2% (wt), even more preferably from about 0.1% (wt) to about 1% (wt) of a high intensity sweetener.

If the high intensity sweetener is sucralose, the cohesive non-free flowing sweetener compositions of the present invention preferably contain from about 0.1% (wt) to about 0.6% (wt) of sucralose. More preferably, the sweetener cubes of the present invention contain from about 0.2% (wt) to about 0.5% (wt), even more preferably from about 0.4% (wt) to about 0.5% (wt) of sucralose based on the weight of the cohesive non-free flowing sweetener composition.

### Bulking Agents

The specific bulking agent(s) are selected to produce sweetener cubes from the cohesive non-free flowing sweetener composition with physical and sensory characteristics similar to those of a sucrose cube. Such sweetener cubes may contain specific bulking agents that have physical and sensory properties similar to sucrose or may contain a combination of bulking agents that individually do not, but when combined do, have characteristics similar to sucrose. Numerous factors must be considered in the selection of bulking agents for use in the present invention.

First, the bulking agent generally has a sweetness intensity well below that of sucrose, so the addition of a high intensity sweetener is required to produce a sweetener cube from the cohesive non-free flowing sweetener composition that has a level of sweetness acceptable to consumers. The amount of high intensity sweetener used in such a sweetener cube is inversely related to the native sweetness of the bulking agent. Care must be taken to properly balance the ingredients to produce the sweetness expected by the consumer that is approximately equal to the sweetness of a sucrose-containing sweetener cube, e.g., one teaspoon of sucrose.

Second, bulking agent(s) must be selected that are acceptable to consumers in roughly five areas: appearance, taste, side effects, use, and cost. With regard to appearance, the sweetener cubes from the cohesive non-free flowing sweetener composition should mirror its sucrose equivalent as much as possible. The sweetener cube should appear crystalline. And, the sweetener cube should maintain its shape during storage and transport. For example, proteins will often have non-crystalline appearance and some sugars have yellow or sallow color. Neither will produce an acceptable sweetening cube when used in isolation as a bulking agent. Moreover, some possible bulking agents are far too hygroscopic to maintain cube integrity and shape for any length of time when used in isolation. For example, soluble fibers may absorb so much water from the environment that the sweetener cubes will begin to dissolve into a syrup that is undesirable to, and often unusable by consumers.

As used herein, the term “bulking agent” means a food grade substance that may be used to produce a sweetener cube with sensory and physical characteristics similar to that of a conventional sucrose cube. Examples of bulking agents for use in the present invention include mono- and disaccharides, such as, glucose, allose, altrose, mannose, idose, galactose, talose, ribose, arabinose, xylose, lyxose, cellobiose, gentiobiose, isomaltose, lactose, laminarabinose, maltose, amylose, mannobiose, xylobiose, trehalose, cellobiose, lactulose, tagatose, lactitol; aerated sugars, aerated polyols, and aerated complex carbohydrates; oligosaccharides and polysaccharides, such as, cyclodextrins, raffinose, cellulose, nutriose, fibrisol, raftiline, raftilose; polyols, such as, isomalt, lactitol, maltitol, xylitol, erythritol, mannitol, sorbitol; soluble fiber; protein; calcium citrate; calcium lactate and combinations thereof. Preferably, the bulking agent is a combination of polydextrose, erythritol, and trehalose.

As used herein, a “food-grade” material is one that conforms to the standards for foods deemed safe for human consumption set forth in the Codex Alimentarius produced by the World Health Organization (1999).

The bulking agent(s) used in the present invention are selected to produce cohesive non-free flowing sweetener compositions that will be readily accepted by consumers as an alternative to sucrose cubes. To maximize consumer appeal and similarity to sucrose bulking agents may be combined as part of this invention when the individual bulking agents do not deliver sufficient of the correct characteristics or deliver negative characteristics. The correct combination of these bulking agents minimizes or eliminates the undesirable characteristics.

Preferably, the cohesive non-free flowing sweetener compositions of the present invention contain from about 1% (wt) to about 99.5% (wt) of a bulking agent. More preferably, the cohesive non-free flowing sweetener compositions of the present invention contain from about 1)% (wt) to about 75% (wt), even more preferably about 30% (wt) to about 60% (wt) of a bulking agent.

The bulking agents may be processed using methods known in the art to achieve a lower density. For example, agglomerated maltodextrin may be produced by fluid bed drying standard maltodextrin and aerated products may be produced by foam spray drying with the incorporation of a dissolved gas (e.g. carbon dioxide) in the feed to the spray dryer. Moreover, lower density forms of the bulking agents may be produced by extrusion and cavitation technologies.

### Disintegrants

As used herein, the term “disintegrant” means any food-grade material that expands in water or allows water to quickly travel to the center of the cube. Disintegrants according to the present invention include any material that rapidly swells in water and any material that produces gas in a liquid environment. Examples of disintegrants for use in the present invention include microcrystalline cellulose, carboxymethyl cellulose, sodium starch glycolate, carboxymethyl starches, corn and potato starches, crosslinked polyacrylate, crosspovidone, n-vinyl-2-pyrrolidone, polacrillin potassium, polyvinylpolypyrolidone, calcium carbonate, sodium bicarbonate/food acid mixes, crosslinked polymers, and combinations thereof. Preferred disintegrants according to the present invention are microcrystalline cellulose, carboxymethyl cellulose, and sodium bicarbonate. Preferably, the disintegrant is present in an amount of about 0.1% (wt) to about 5% (wt) based on the total weight of the sweetener cube.

The sweetener cubes of the present invention quickly dissolve in the liquid foodstuff to produce the desired sweetness in the manner expected by the consumer. However, some bulking agents that are desirable due to low caloric burden have a low solubility in water. Sweetener cubes made using these bulking agents may dissolve too slowly for the consumer or may not dissolve completely. The addition of a disintegrant allows the sweetener cube to quickly disintegrate and deliver the desired sweetness to the liquid foodstuff, even when a slow-dissolving bulking agent is employed.

Moreover, even if the bulking agent has a high solubility in water the addition of a disintegrant will speed dissolution of the cube. The ability to customize the speed of dissolution of a cube allows for greater control over sweetness release into the foodstuff.

### Producing Cohesive Non-free Flowing Sweetener Compositions

Cohesive non-free flowing sweetener compositions are generally produced by a process having the following steps: (a) blending the ingredients, (b) forming a shaped composition, and (c) drying the composition. Obviously, each step may have a number of variations.

A further embodiment of the present invention is a method for making a low-calorie cohesive non-free flowing composition including the steps of combining a high intensity sweetener, a bulking agent, and a disintegrant to form a blend, adding water to the blend, forming the blend into a shape, and drying the shape.

While the manner in which the ingredients are blended is not critical, overly aggressive blending may result in an undesirable particle size reduction. It is, however, imperative to have a uniform distribution of the ingredients throughout the blend. Otherwise, both the sweetness and the caloric burden will vary from shape to shape. For ingredients used in small amounts it may be necessary to produce a pre-blend to ensure even distribution. If an ingredient tends to cake or lump, it may need to be passed through a sieve. The most common blenders are those that allow for continuous addition of ingredients.

Forming the cohesive non-free flowing sweetener composition generally has two phases. First, the blended ingredients are hydrated to a moisture content from about 0.3% to about 3%, usually by the introduction of water or steam. Second, the hydrated ingredients are placed into dyes or molds and compressed to form the desired shape. The hydrated mixture may also be formed into large blocks and later broken into “rough cut” shapes.

Once the hydrated mixture has been formed into the desired shape it is dried. Drying may be accomplished using ovens or, if conditions permit, by exposure to ambient air. The most common dryers are continuous bands passing through a drying tunnel. Drying temperatures and times vary considerably. For example, in ambient air the drying time may be abpit 24 hours. In contrast, drying in an oven at about 60° C. to about 75° C. can take as little as about 10 to about 20 minutes. A conditioning step may also be required after oven or air-drying of approximately about 12 to about 36 hours to allow moisture to equilibrate throughout the products.

The shape of the mold chosen to form the cohesive non-free flowing sweetener composition determines the overall shape of the cohesive non-free flowing sweetener composition. Any desired shape can be used, including, cube, ball, pyramid, and the like. Additionally, the surface of the cohesive non-free flowing sweetener composition may modified to introduce a feature. A surface feature may be imparted by the surface of the mold used to form the cohesive non-free flowing sweetener composition or the dried cohesive non-free flowing sweetener composition may be further processed to produce the desired surface feature. In addition, the cohesive non-free flowing sweetener composition may also be shaped when still damp to introduce surface features or to produce novel shapes. For example, the dried cohesive non-free flowing sweetener composition may be laser or mechanically etched, or the desired feature may be burned into the surface of the cohesive non-free flowing sweetener composition using a heated tool. Once dry, the cohesive non-free flowing sweetener composition is then packed into tubs, boxes or other food appropriate packaging prior to consumer use.

Another embodiment of the present invention is a sweetener cube formed from a cohesive non-free flowing sweetener composition that is made according to one of the processes described herein.

Cohesive non-free flowing sweetener compositions of the present invention may be of any size convenient for manufacture and acceptable for use by a consumer. Cubes formed of the cohesive non-free flowing sweetener compositions are generally less than about 20 millimeters in height, less than about 20 millimeters in width, and less than about 20 millimeters in depth. Other useful sizes include about 12 millimeters in height, about 12 millimeters in width, and about 9 millimeters in depth, and even more preferably about 9 millimeters in height, about 9 millimeters in width, and about 9 millimeters in depth.

### Consumer Preferences

A conventional sucrose cube is the standard to which all other sweetening cube products are compared. Any sweetening cube product that deviates significantly from the physical and sensory characteristics of a conventional sucrose cube is not likely to be acceptable to the consumer. Table 1 shows physical and sensory characteristics of sucrose cubes and acceptable ranges for other sweetening cube products.

TABLE 1
Physical and sensory characteristics of sucrose cubes and acceptable
ranges for other sweetening cube products.

| Characteristic | Sucrose cube | Acceptable range |
|---|---|---|
| Appearance | White, crystalline | Color from white to pale cream, crystalline |
| Taste | Sweet, syrupy | Delivery of sweetness, no other strong |
| | | flavor notes (i.e. any additional flavors |
| | | must not be stronger than the sweetness) |
| Undesirable | None | Minimal negative consumer related claims |
| effects | | such as laxative effect |
| Stability | Maintains shape during | Maintains shape during processing and |
| | storage and transport | transport up to 75% RH |
| Solubility | Approx. 30 seconds in hot | Dissolves in hot water (150 ml at 85° C.) in |
| | water (85° C.) | about 10 to about 60 seconds with agitation |
| Friability | Maintains integrity on | Less than 10% weight loss from dry cube |
| | handling | when agitated for 60 seconds |
| Hardness | 4000 g pressure (bench | 1,000–15,000 g for laboratory made |
| | made), 25,000 machine | samples, up to 30,000 g for pilot scale/ |
| | made (texture analyzer) | commercially made samples |
| Particulate size | 0–2 millimeters | 0–3 millimeters for overall blend of |
| range | | ingredients used to make up the cube |

To be accepted by a consumer as an acceptable substitute for a conventional sucrose cube, a sweetener cube of the present invention must have enough sensory and physical characteristics within the acceptable ranges shown in Table 1. Every characteristic of the sweetener cube need not fall within the ranges in Table 1 for the sweetener cube to be acceptable to a consumer. For example, a sweetener cube of the present invention intended to replace a brown sugar cube would have a brown color, and therefore, would not fall with the acceptable range for “appearance” in Table 1, but would still be acceptable to a consumer.

With regard to taste, a sweetener cube formed from a cohesive non-free flowing sweetener composition of the present invention should give a sweetness level equivalent to a similar weight of sucrose cube, and deliver a sweetness profile similar to sucrose. With regard to side effects, the bulking agent and disintegrant must not produce undesirable or unexpected side effects for the consumer. For example, some sugar alcohols may have a laxative effect on the consumer. Unless this is a desired effect, a cohesive non-free flowing sweetener composition employing such sugar alcohols would not find consumer acceptance.

The cohesive non-free flowing sweetener compositions must also function as expected by the consumer and quickly dissolve to produce the desired sweetness in the foodstuff. For example, the hulking agent may have a low solubility in water, and therefore, the sweetener cube may dissolve too slowly for the consumer or may not dissolve completely. As noted above, the production of sweetener cubes with desirable consumer characteristics may be achieved either by the use of a single bulking agent with the desired characteristics or by the use of a combination bulking, agents that together produce the desired characteristics.

With regard to cost, the cohesive non-free flowing sweetener compositions should be of acceptable cost to the consumer when compared with other sweetening formats, such as tablets, sucrose cubes, sucrose, high intensity sweeteners, and granular sweeteners. For example, erythritol may be sourced commercially in a white crystalline format of good particulate size similar to sucrose, but may be comparatively expensive; therefore this may be combined with a less expensive bulking agent such as maltose and still provide the required overall characteristics.

Overlapping with the above considerations are various bulking agent characteristics that affect the production and/or storage and transport of sweetener cubes. These characteristics include: caloric content, friability, dissolution, heat of solution, hardness, rigidity, moisture uptake, effect of humidity, and effect of temperature. Processing considerations include case of raw material storage and processing and ease of flow of mixture for consistent and accurate fill of molds. Table 2 lists various ingredients and factors that must be considered in screening for the proper bulking agent(s) for use in a non-free flowing sweetener compositions according to the present invention.

TABLE 2
Potential bulking agents.

| Ingredient | | | | Screening Factors | |
|---|---|---|---|---|---|
| Class | Subclass | Examples | kcal/g | Negatives | Positives |
| Protein | | | 4.0 | Non-crystal appearance | |
| Carbohydrates | Sugars | Sucrose | 4.0 | Consumer negative | |
| | | Fructose | 4.0 | Hygroscopic | |
| | | Lactose | 4.0 | Mostly Small particulates | Low cost |
| | | Galactose | 4.0 | High cost | |
| | | Maltose | 4.0 | | Low cost, Crystalline |
| | | Trehalose | 4.0 | | Excellent appearance |
| | | Tagatose | 1.5 | | Crystalline, Low calorie |
| | Sugar alcohols | Mannitol | 1.6 | Laxative effect | |
| | | Sorbitol | 2.6 | Laxative effect | |
| | | Xylitol | 2.4 | Laxative effect | |
| | | Erythritol | 0.2 | Negative heat of solution | |
| | Complex | Maltodextrin | 4.0 | Non crystalline | Low cost bulking |
| | Carbohydrates | | | | Glue effect |
| | | Polydextrose | 1.0 | Non crystalline | Glue effect |
| | | Soluble Fiber | 1.0–2.0 | Hygroscopic, Laxative | |
| Minerals | | Ca citrate | 2.0 | | Powdery, Possible bulk |
| | | Ca lactate | 2.0 | | Powdery, Possible bulk |

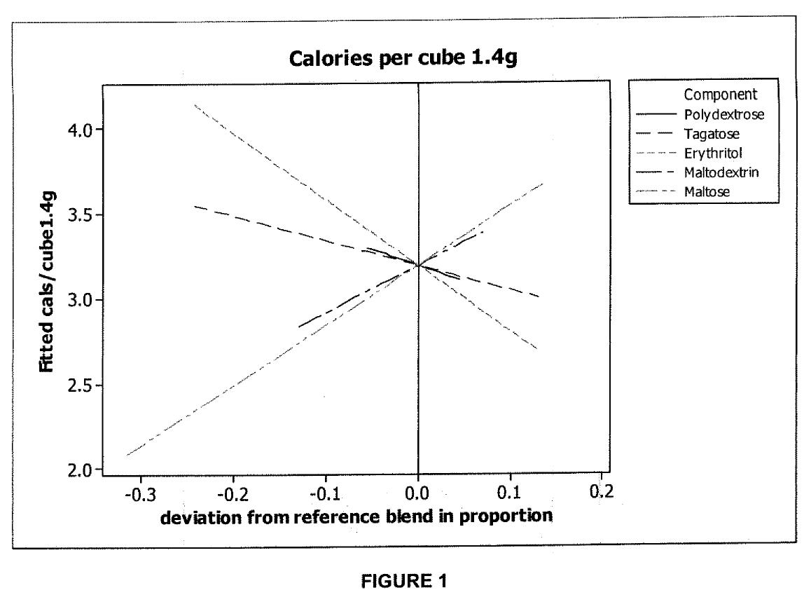

Even if an ingredient is appropriate for use as a bulking agent the proportion of the ingredient used in the cohesive non-free flowing sweetener composition may have significant effects on the characteristics of the composition. For example, FIG. 1 shows the caloric burden as a function of ingredient content for various potential bulking agents. An increase in the maltose or maltodextrin compared to the reference blend increases the caloric burden. In contrast, increases in the proportion of the other ingredients results in a reduction of the caloric burden.

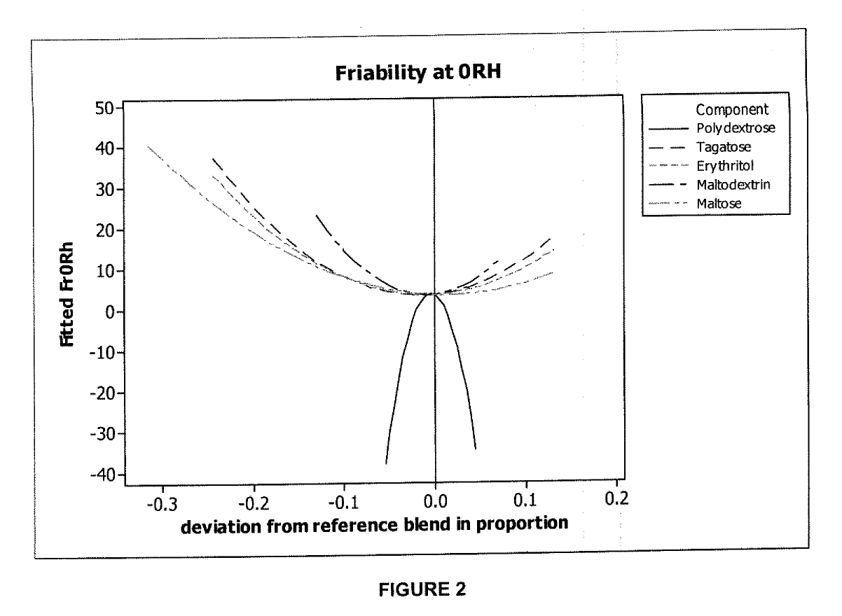

FIG. 2 shows the effect of changing the proportion of various potential hulking agents and polydextrose as compared to a reference blend on friability over a range of relative humidities.

The reference blend is a composition used only as a starting point for measuring the changes in the physical properties of the composition as the proportion of one of the components is varied. The composition of the reference blend for FIGS. 1 and 2 and the variation of the components are shown in Table 3.

TABLE 3
Reference blend and component variation for FIGS. 1 and 2.

| | Reference Blend | Variation |
|---|---|---|
| Component | % (wt) | % (wt) |
| Polydextrose | 9.85 | 0 to 10 |
| Tagatose | 26.6 | 0 to 37.5 |
| Erythritol | 10.85 | 0 to 37.5 |
| Maltodextrin | 7.6 | 0 to 20 |
| Maltose | 44.5 | 0 to 45 |
| Sucralose | 0.6 | None |

Likewise, other ingredient characteristics may be evaluated and the formula may be optimized to produce a sweetener cube with high commercial viability and consumer acceptance.

Another embodiment of the present invention is a low-calorie sweetener cube made according to one of the processes described herein

The following examples are provided to further illustrate the compositions and methods of the present invention. These examples are illustrative only and are not intended to limit the scope of the invention in any way.

### EXAMPLES

The cohesive non-free flowing sweetener compositions of the present invention may be made in any manner known in the art. Described below are two methods for producing cohesive non-free flowing sweetener compositions of the present invention: A) a laboratory scale preparation method and B) a larger production scale preparation method.

### A. Laboratory Scale Preparation Method

All ingredients are weighed. The weighed ingredients are placed into a glass jar and blended in a tubular mixer for five minutes. The blended ingredients are then spread as thinly as possible along a flat surface to achieve a layer as close to a one particle thick as possible.

A short burst of water is then sprayed across the layer of blended ingredients with an aerosol pump. The desired amount of water may be measured before addition into the aerosol pump. (For granulated sugar, for example, water added is typically about 3.5 milliliters per 100 grams of sugar.) The blended ingredients are then mixed with a pallet knife.

To determine if enough water has been added, some of the blended ingredients are placed into a cube mold. Using the appropriate stamp, as much of the blended ingredients as possible are compacted into the mold, adding compression on both sides to increase pressure. Once the mold is full the stamp is used to push out the blended ingredients.

If the cube breaks immediately and granules disperse, there is not enough moisture. The blended ingredients are then spread, sprayed with additional water, and mixed again with the pallet knife. The blended ingredients are then re-evaluated for water content.

On the other hand, if clumps are present and part of the cube remains in the mold, too much moisture has been added to the blended ingredients. In this case, the blended ingredients must be discarded and the process restarted from the beginning.

Once an appropriate amount of water has been added, the blended ingredients are compressed in molds. The molded compositions are then placed onto a tray and dried at 70° C. in an oven. One cube is broken in half about every 10 minutes to assess breakability due to moisture content. Once the water has been removed from the cubes they should be hard throughout. The drying should take about 10 to about 30 minutes. If further drying is desired, the cubes may be placed in a 30° C. room overnight.

### B. Production Scale Preparation Method

All ingredients are weighed and blended to uniformity. The blended ingredients are then transferred to a powder hopper above a cube machine (Type C Cube Machine, Teknikeller, Ankara, Turkey). The blended ingredients are added to the mixing chamber of the cube machine and mixed with water. The amount of water is adjusted to ensure good distribution of water throughout the blended ingredients. Insufficient water will produce deposits of powder on the extraction belt used to transport cubes to the oven and result in friable cubes. Over-wetting the blended ingredients will produce visibly wet cubes, the cubes will be hard, but will have lost the sparkle associated with the glassy surface of individual crystals in conventional sucrose cubes. Target blend moisture content is about 0.5% to about 1.0%, depending on cube appearance.

The wet blended ingredients then fall by gravity from the belt into a rotating mold. Pistons compress the cubes to the required dimensions. The mass of the cubes may be adjusted by tightening the compression plate or by altering the amount of travel of the pistons. The pistons push out the formed cube onto the extraction belt, and a pushing arm pushes the cubes onto a chain conveyor to pass the cubes into the drying oven.

The shape of the mold chosen to form the cubes determines the overall shape of the cube.

The cubes may then be dried in a static oven or by using a conveying (tunnel) oven. Temperatures should not exceed 70° C. for 10 to 30 minutes. The cubes may need to be “tempered” prior to packing and should cool from the drying temperature to room temperature prior to packing to avoid accumulation of condensation inside the packaging.

As discussed above the cubes may be further processed to introduce a surface feature onto the surface of the cube.

The cohesive non-free flowing sweetener compositions of the following examples may be formed using either of the two methods above.

### Example 2

Sweetener cubes of the present invention are made using the laboratory scale preparation method of Example 1.A. containing the following ingredients:

0.3% (wt) to 0.6% (wt) sucralose,

0.1% (wt) to 5% (wt) carboxymethyl cellulose,

5% (wt) to 10% (wt) polydextrose,

50% (wt) to 75% (wt) erythritol, and

0% (wt) to 15% (wt) maltodextrin.

### Example 3

Sweetener cubes of the present invention are made using the laboratory scale preparation method of Example 1.A. containing the following ingredients:

0.57% (wt) sucralose,

5% (wt) carboxymethyl cellulose,

5% (wt) polydextrose,

56.6% (wt) to 75% (wt) erythritol, and

14% (wt) maltodextrin.

### Example 4

Cohesive non-free flowing sweetener compositions of the present invention having the ingredients in Table 4 are produced using the laboratory scale preparation method of Example 1.A.

| | | | | | | | | | | Percent | |
|---|---|---|---|---|---|---|---|---|---|---|---|
| | | | | | Disintegrant | | | | | Decrease in | |
| | | | | | | | Bicarbonate | Dissolution Time | | Dissolution | |
| Formu- | Sucralose | Polydextrose | Erythritol | Trehalose | Carboxymethyl | Polyplasdone | and Citric | (s) | | Time | |
| lation | (% wt) | (% wt) | (% wt) | (% wt) | Cellulose (% wt) | (% wt) | Acid (% wt) | Ambient | 55° C. | Ambient | 55° C. |
| A | 0.40 | 10.00 | 37.50 | 52.10 | — | — | | 210 | 82 | — | — |
| B | 0.40 | 9.75 | 36.55 | 50.80 | 2.5 | — | | 150 | 37 | 28.6 | 54.9 |
| C | 0.40 | 9.25 | 34.65 | 48.20 | 7.5 | — | | 21 | 15 | 90.0 | 81.7 |
| D | 0.40 | 9.75 | 36.55 | 50.80 | — | 2.5 | | 150 | 65 | 28.6 | 20.7 |
| E | 0.40 | 9.25 | 34.65 | 48.20 | — | 7.5 | | 210 | 210 | 0.0 | −156.0 |
| F | 0.40 | 9.50 | 35.60 | 49.50 | — | — | 5.0 | 195 | 155 | 7.1 | −89.0 |

FIG. 4. Sweetener cube Dissolution times at ambient temperature and 55° C. for various added disintegrants.

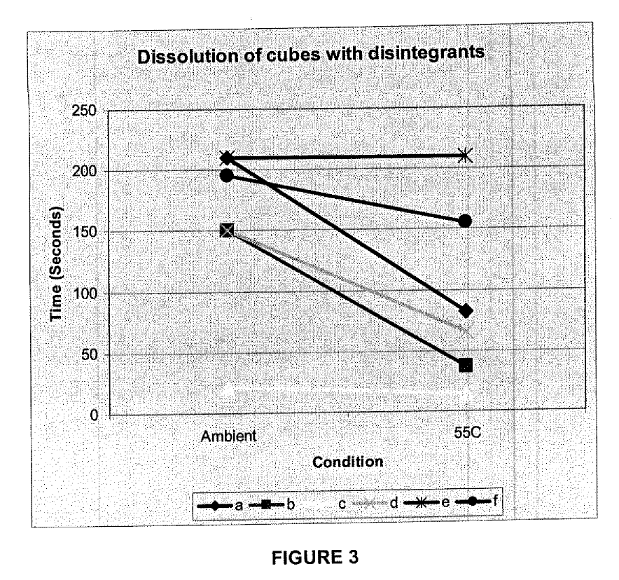

FIG. 3 shows the dissolution time for the formulations above at ambient temperature and 55° C.

The scope of the present invention is not limited by the description, examples, and suggested uses herein and modifications can be made without departing from the spirit of the invention. Thus, it is intended that the present invention cover modifications and variations of this invention provided that they come within the scope of the appended claims and their equivalents. Unless otherwise defined, all technical and scientific terms used herein have the same meaning as commonly understood by one of ordinary skill in the art to which this invention pertains. All publications, patent applications, patents, and other references mentioned herein are incorporated reference in their entirety. In case of conflict, the present specification, including definitions, will control.

What is claimed is:

1. A cohesive non-free flowing sweetener composition comprising a sweetening amount of a intensity sweetener, an effective amount of a bulking agent, and a effective amount of a disintegrant, wherein a sweetener cube formed from the cohesive non-free flowing sweetener composition having about the same dimensions as a convention sucrose cube has a lower caloric burden and an equivalent sweetness and the bulking agent and disintegrant are different substances.

2. A cohesive non-free flowing sweetener composition according to claim 1, wherein the disintegrant is selected from the group consisting of microcrystalline cellulose, carboxymethyl cellulose, sodium starch glycolate, carboxymethyl starches, corn and potato starches, crosslinked polyacrylate, crosspovidone, n-vinyl-2-pyrrolidone, polacrillin potassium, polyvinylpolypyrolidone, calcium carbonate, sodium bicarbonate/food acid mixes, crosslinked polymers, and combinations thereof.

3. A cohesive non-free flowing sweetener composition according to claim 2, wherein the disintegrant is selected from the group consisting of microcrystalline cellulose, carboxymethyl cellulose, sodium bicarbonate, and combinations thereof.

4. A cohesive non-free flowing sweetener composition according to claim 1, wherein the disintegrant is present in the cohesive non-free flowing sweetener composition in an amount of about 0.1% to about 5% based on the total weight of the cohesive non-free flowing sweetener compositions.

5. A cohesive non-free flowing sweetener composition according to claim 1, wherein the bulking agent is selected from the group consisting of glucose, allose, altrose, mannose, idose, galactose, talose, ribose, arabinose, xylose, lyxose, cellobiose, gentiobiose, isomaltose, lactose, laminarabinose, maltose, amylose, mannobiose, xylobiose, trehalose, cellobiose, lactulose, fructose, tagatose, lactitol, aerated sucrose, aerated sugars, aerated polyols, aerated complex carbohydrates, cyclodextrins, raffinose, cellulose, inulin, gum arabic, nutriose, maltodextrin, fibrisol, raftiline, raftilose, isomalt, lactitol, maltitol, xylitol, erythritol, mannitol, sorbitol, soluble fiber, protein, calcium citrate, calcium lactate, and combinations thereof.

6. A cohesive non-free flowing sweetener composition according to claim 5, wherein the bulking agent is selected from the group consisting of maltose, trehalose, tagatose, erythritol, maltodextrin, polydextrose, lactose, and combinations thereof.

7. A cohesive non-free flowing sweetener composition according to claim 1, wherein the high intensity sweetener is selected from the group consisting of aspartame, acesulfame, alitame, brazzein, cyclamic acid, dihydrochalcones, extract of Dioscorophyllum cumminsii, extract of the fruit of Pentadiplandra brazzeana, glycyrrhizin, hernandulcin, monellin, mogroside, neotame, neohesperidin, saccharin, sucralose, stevia, thaumatin, salts, derivatives, and combinations thereof.

8. A cohesive non-free flowing sweetener composition according to claim 7, wherein the high intensity sweetener is sucralose.

9. A cohesive non-free flowing sweetener composition comprising about 0.3% to about 0.6% sucralose, about 0.1% to about 5% carboxymethyl cellulose, about 5% to about 10% polydextrose, about 14% to about 15% trehalose, and about 60% erythritol by weight based on the total weight of the cohesive non-free flowing sweetener, wherein the cohesive non-free flowing sweetener composition has a lower caloric burden and a equivalent sweetness to a shaped sucrose composition of similar size.

10. A cohesive non-free flowing sweetener composition comprising about 0.57% sucralose, about 5% carboxymethyl cellulose, about 5% polydextrose, about 14% trehalose, and about 60% erythritol by weight based on the total weight of the sweetener cube, wherein the cohesive non-free flowing sweetener composition has a lower caloric burden and a equivalent sweetness to a shaped sucrose composition of similar size.

11. A method for making a low-calorie sweetener cohesive non-free flowing composition comprising:
(a) combining a high intensity sweetener, a bulking agent, and a disintegrant to form a blend, wherein the bulking agent and disintegrant are different substances;
(b) adding water to the blend;
(c) forming the blend from (b) into a shape; and
(d) drying the shape.

12. A low-calorie sweetener cube made by the method of claim 11.
